(19) United States
(12) Patent Application Publication
(10) Pub. No.: US 2014/0136359 A1
(43) Pub. Date: May 15, 2014

(54) Pillow Apparatus Having An Insertable Pillow

(71) Applicant: Diane Gross, Chesapeake, VA (US)

(72) Inventor: Diane Gross, Chesapeake, VA (US)

(21) Appl. No.: 14/081,925

(22) Filed: Nov. 15, 2013

Related U.S. Application Data
(60) Provisional application No. 61/726,574, filed on Nov. 15, 2012.

(51) Int. Cl. G06Q 50/00; G06Q 30/06; A47G 9/10

(52) U.S. Cl. CPC G06Q 50/01; A47G 9/10; G06Q 30/0621
USPC 705/26.5; 5/645

(57) ABSTRACT

A pillow apparatus, social media network and methods for ordering and designing the pillow apparatus is provided. The pillow apparatus including a first pillow including a receiving pillow pocket in an interior portion thereof, and an opening at a side surface of the pillow corresponding to the receiving pillow pocket; a second pillow formed of a different size than that of the first pillow; and a connection portion configured to couple the first pillow and the second pillow together, wherein the second pillow is insertable into and housed within the receiving pillow pocket of the first pillow.

### CROSS-REFERENCE

The Present Application is a Non-provisional Application claiming priority to the Provisional Application Ser. No. 61,726,574 filed on Nov. 15, 2012, incorporated the contents thereof in its entirety.

### BACKGROUND OF THE INVENTION

The present invention relates to pillow apparatus having a plurality of pillows coupled together and one insertable into another, a social network and manufacturing and ordering methods thereof.

Pillows have long been used to provide physical comfort to a user. Pillows are used when sleeping, traveling and as a decorative ornament. They are typically used for providing added physical comfort to the user.

### SUMMARY OF THE INVENTION

According to an embodiment of the present invention, a pillow apparatus is provided. The pillow apparatus comprising a first pillow including a receiving pillow pocket in an interior portion thereof, and an opening at a side surface of the pillow corresponding to the receiving pillow pocket; a second pillow formed of a different size than that of the first pillow; a connection portion configured to couple the first pillow and the second pillow together, wherein the second pillow is insertable into and housed within the receiving pillow pocket of the first pillow.

According to another embodiment of the present invention, a social network operable via a computing device, and comprising a method including: accessing the social network; creating and storing a member profile; creating at least one design of a pillow apparatus as described above; sharing the design with other members of the social network; purchasing at least one design; following other members of the social network; receiving member recommended products and other items/articles; and viewing member created videos regarding designs of pillow apparatuses; and receiving external/cross marketing offers.

According to other embodiments of the present invention, manufacturing and ordering methods of the above-identified pillow apparatus are also provided.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a front view illustrating a pillow apparatus that can be implemented within one or more embodiments of the present invention;

FIG. 2 is a front view illustrating a pillow receiving pocket of a first pillow of the pillow apparatus shown in FIG. 1 according to one or more embodiments;

FIG. 3 is a front view illustrating a second pillow of the pillow apparatus being inserted into and housed within the first pillow shown in FIG. 1 according to one or more embodiments;

FIG. 4 is a flow diagram illustrating a method of ordering a pillow apparatus that can be implemented within embodiments of the present invention;

FIG. 5 is a screenshot of a performance of the method shown in FIG. 4, according to one or more embodiments of the present invention;

FIG. 6 is a block diagram of a general purpose computer that can be implemented within one or more embodiments; and

FIG. 7 is a flow diagram of accessing a social network for creating a pillow apparatus, according to one or more embodiments.

FIG. 8 is a flow diagram of a back end ordering process that can be implemented within one or more embodiments of the present invention.

FIG. 9 is a flow diagram of a front end ordering process that can be implemented within one or more embodiments.

FIG. 10A and 10B are screenshots illustrating design operations of the wizard process of FIG. 9, for the first pillow of the pillow apparatus that can be implemented within one or more embodiments.

FIG. 11A and 11B are screenshots illustrating design operations of the wizard process of FIG. 8, for the second pillow of the pillow apparatus that can be implemented within one or more embodiments.

### DETAILED DESCRIPTION OF THE INVENTION

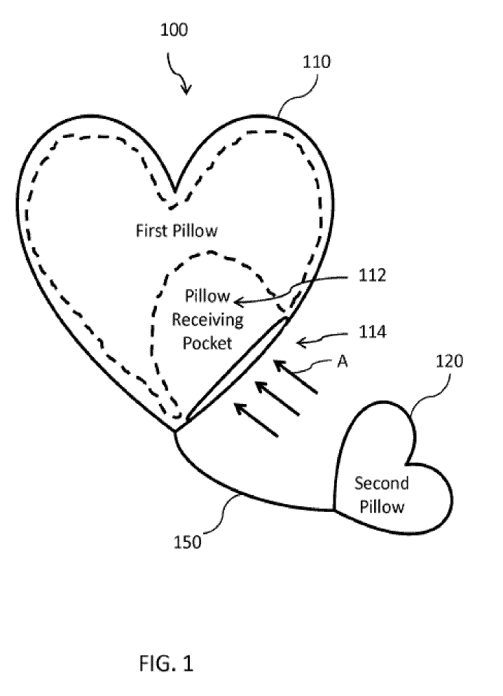

FIG. 1 is a front view illustrating a pillow apparatus that can be implemented within one or more embodiments of the present invention. As shown in FIG. 1, the pillow apparatus 100 is provided. The pillow apparatus 100 comprising a first pillow 110 including a receiving pillow pocket 112 in an interior portion thereof, and an opening 114 at a side surface of the first pillow 110 corresponding to the receiving pillow pocket 112.

According to an embodiment of the present invention, a second pillow 120 formed of a different size than that of the first pillow 110 is also provided. The pillow apparatus 100 further includes a connection portion 150 configured to couple the first pillow 110 and the second pillow 120 together. As further shown in FIG. 1, the pillow receiving pocket 112 is formed a size comparable to that of the second pillow 120, to thereby receiving and house the second pillow 120 therein.

According to one or more embodiments, the first pillow 110 and the second pillow 120 are formed of various shapes and sizes. In one embodiment, the first and second pillows 110 and 120 are formed in a heart shape. However, the first and second pillows 110 and 120 are not limited hereto. According to alternative embodiments, the first and second pillows 110 and 120 are formed of any shape and/or size as desired by a user. According to one embodiment, the second pillow 120 is smaller than the first pillow 110 in order to be inserted into and housed within the first pillow 110. The second pillow 120 is inserted into the opening 114 in a direction as shown via a plurality of arrows A.

According to an embodiment of the pillow receiving pocket 112 is a multifunctional storage containment area. It can be made of various materials what will store and protect the contents inside the pillow. According to one or more embodiments, the material may be temperature resistant. The pillow receiving pocket 112 can store: liquids, solids, metals, perishables, protection from radiation, unwanted moisture and environment elements exterior to the pocket 112. The first pillow 110 and the second pillow 112 can be formed of the same materials or they may be formed of different materials.

According to one or more embodiments, various types of closure attachments may be implemented. For example, zippers, snaps, buttons, clips, Velcro, straps etc. may be used to hold and secure the items within the pocket 112. All closures can be multiple and various in nature, content, composition, shape, size, materials, function and purpose and for aesthetic reasons as well. Large and small pillow pouch closures can be the same closure type of different closure types.

The connection portion 150 can be made of, consist of and be constructed of various materials within one single connector unit. Further, the connection portion 150 can be various lengths, sizes, diameters and dimensions, shapes, materials. It acts as a conduit in some embodiments. That is, the connection portion 150 can function as a conduit for another object to move inside the cord or enable an object to be attached outside the connection portion 150, to the connection portion 150. The object would be visible to touch, see, feel to enable learning, hands on activities for nursery school children, for elderly or disabled personnel, etc. (multiple functions both for recreation, learning sentiment memory attachments, all to aid in an activity or for sentimental keepsake, memories, both for personal and commercial uses. The connection portion 150 may include multiple connection portions for the purpose of having more than one second pillow 120 attached thereof Further, other items may be attached to the first pillow 110 via the connection portion 150 instead of the second pillow 120. For example, toys, food groups, family tree units, etc. as desired.

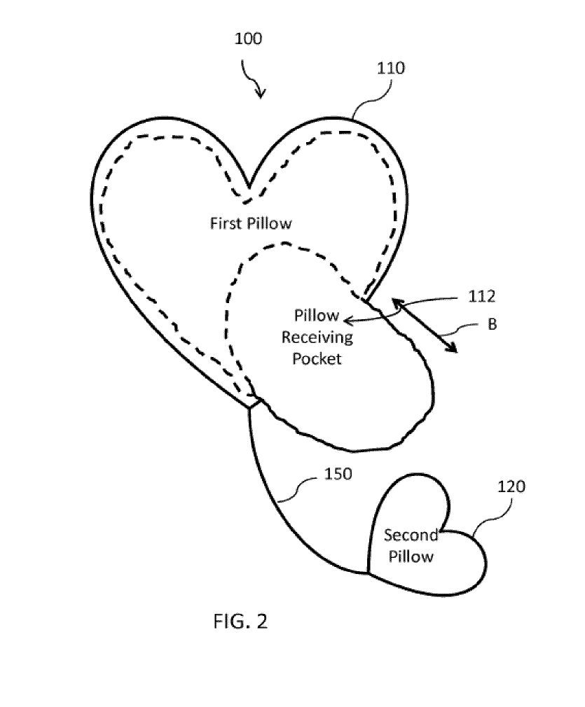

FIG. 2 is a front view illustrating the pillow receiving pocket 112 of the first pillow 110 of the pillow apparatus 100 shown in FIG. 1 according to one or more embodiments. As shown in FIG. 2, the pillow receiving pocket 112 is able to be extended to an exterior surface of the first pillow 110 in a direction indicated by arrow B. The pillow receiving pocket 112 is formed of a size comparable to that of the second pillow 120 to thereby receive the second pillow 120 when the pillow receiving pocket 112 is tucked into the first pillow 110.

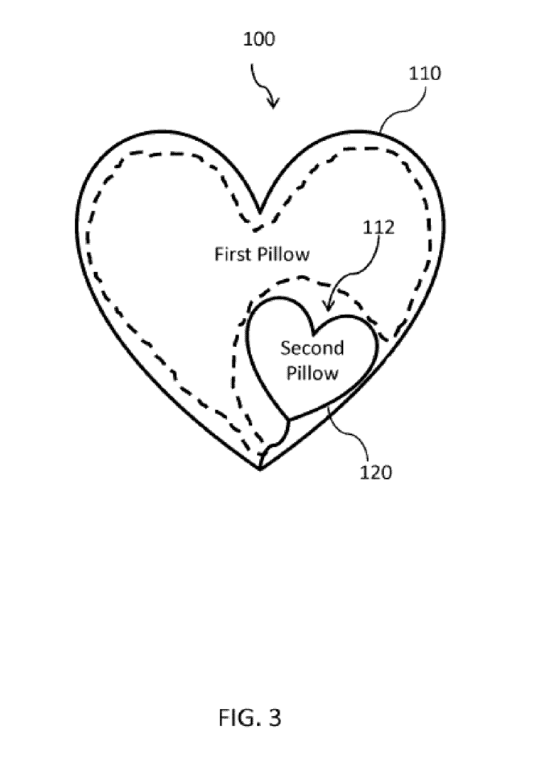

FIG. 3 is a front view illustrating the second pillow 120 of the pillow apparatus 100 being inserted into and housed within the first pillow 110 shown in FIG. 1 according to one or more embodiments. As shown in FIG. 3, the second pillow 120 is inserted into the first pillow 110. According to one or more embodiments, the second pillow 120 is able to be snug-fit into the first pillow 110 such that the second pillow 120 is able to be held without being released from within the first pillow 110, when in a housed position therein.

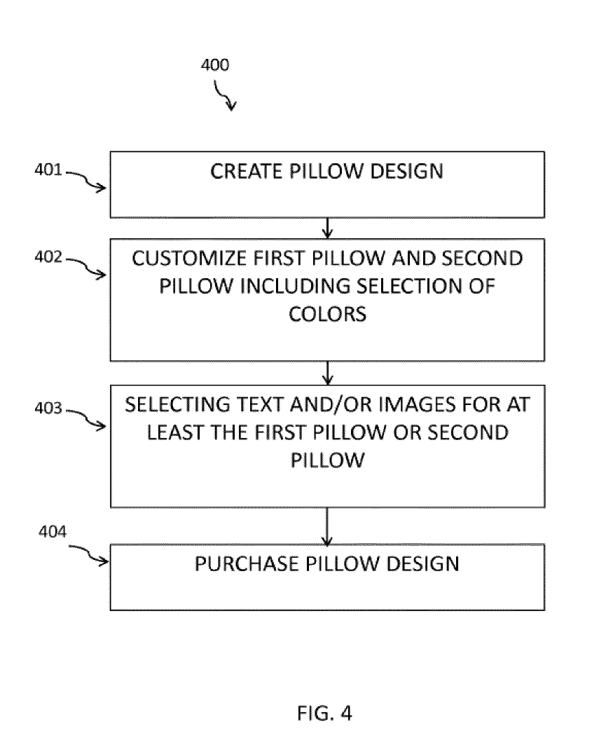

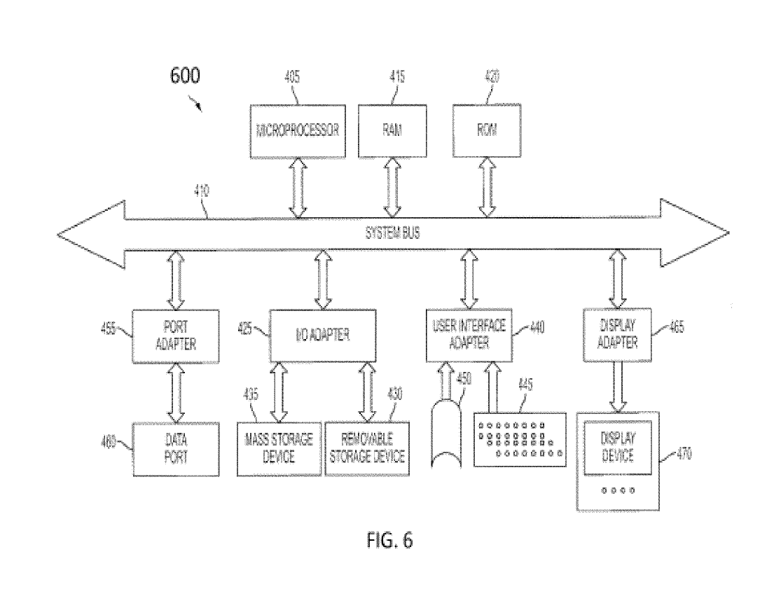

FIG. 4 is a flow diagram illustrating a method of ordering a pillow apparatus that can be implemented within embodiments of the present invention. As shown in the method 400, the process begins at method 400 where a user logs into a website, for example, via a computing device (as depicted in FIG. 6, for example) to thereby design the pillow apparatus 110. According to an embodiment of the present invention, the computing device may be a personal computer, portable computer (e.g., laptop, PDA), or mobile phone having a design application downloaded or installed thereon, for example. The present invention is not limited to the use of any particular computing device for ordering the pillow apparatus 110. At operation 401, the user creates a pillow design. According to one or more embodiments, the pillow design may be created by selection of a shape and size of the pillow apparatus to be created. The user is not limited to any particular shape or size. The user will select a shape and size of the first pillow and the second pillow to be created.

Next at operation 402, the user customizes the first pillow and the second pillow by selecting colors, for example, as desired. The process then continues to operation 403 where the user selects text and/or images for at least the first pillow or the second pillow. According to one or more embodiments, the user may desire to have a text message on the first pillow while the user may desire to have an image on the second pillow, or vice versa. Alternatively, the user may desire to have a text message and image on both the first pillow and the second pillow. The user is able to select a font, style, shape, size of text and/or images as desired. From operation, 403, the process continues to operation 404 where the user is then able to purchase the pillow apparatus as designed. The pillow apparatus of the present invention is not limited to being manufactured in a particular process and therefore the method may be varied as desired. Further, any suitable method of manufacturing may be implemented herein.

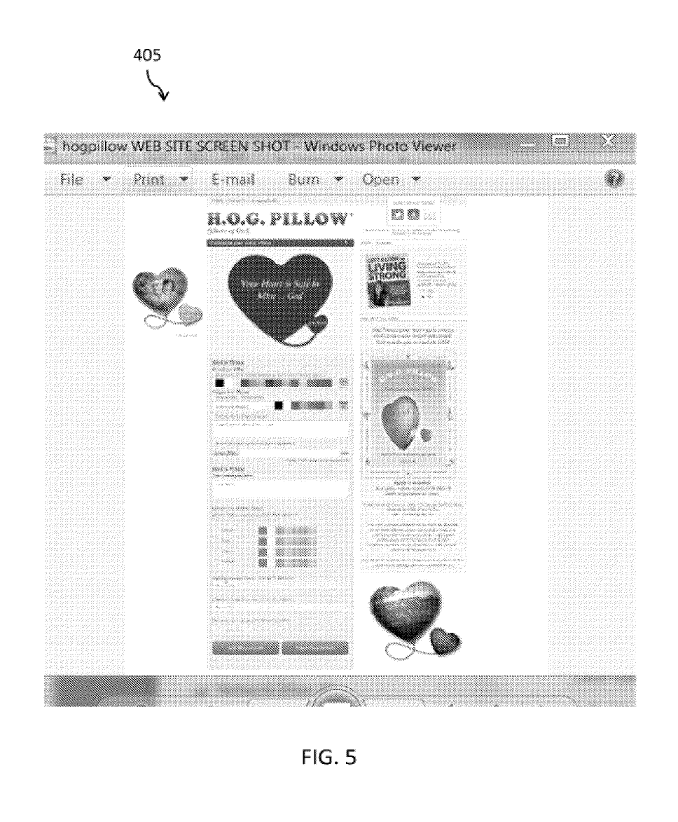

FIG. 5 is a screenshot of a performance of the method shown in FIG. 4, according to one or more embodiments of the present invention. As shown in FIG. 5, the user is able to visualize how their pillow design of the pillow apparatus 100 will appear upon completion. As mentioned above, with reference to FIG. 4, the user is able to select a shape, size and color of the design along with a customized/personalized message and/or image on one or both of the first pillow 110 and the second pillow 120 of the pillow apparatus 100.

FIG. 6 is a block diagram of a general purpose computer that can be implemented within one or more embodiments. In FIG. 6, a computer system 600 is provided. The computer system 600 includes at least one microprocessor or central processing unit (CPU) 405. The CPU 405 is interconnected via a system bus 410 to a random access memory (RAM) 415, a read-only memory (ROM) 420, an input/output (I/O) adapter 425 for connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

The ROM 420 contains the basic operating system for the computer system 400. The operating system may alternatively reside in the RAM 415 or elsewhere as is known in the art. Examples or removable data and/or program storage device 430 include magnetic media such as floppy drives and tape drives and optical media such as CD ROM drives. Examples of mass data and/or program storage device 435 include hard disk drives and non-volatile memory such as flash memory. In addition to the keyboard 445 and the mouse 450, other user input devices such as trackballs, writing tablets, pressure pads, microphones, light pens, and position sensing screen displays may be connected to user the user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using the keyboard 445.

In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the invention. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

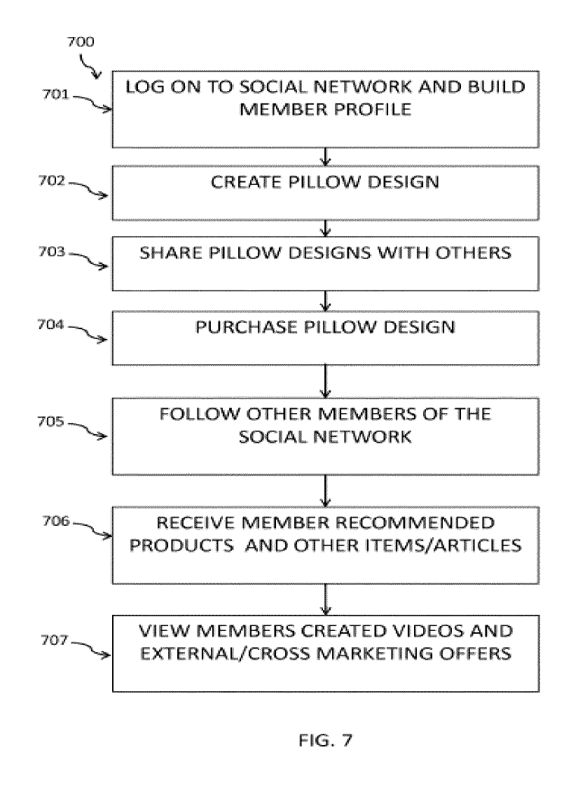

FIG. 7 is a flow diagram of accessing a social network for creating a pillow apparatus 100, according to one or more embodiments. A social network operable via a computing device (e.g., computer system 600) is provided. A method 700 is performed. The method begins as operation 701, accessing the social network and creating and storing a member profile. From operation 701, the process continues to operation 702, creating at least one design of a pillow apparatus as described above. From operation 702, the process continues to operation 703 sharing the design with other members of the social network.

From operation 703, the process continues to operation 704 purchasing at least one design. Then, in operation 705, the user is able to follow other members of the social network.

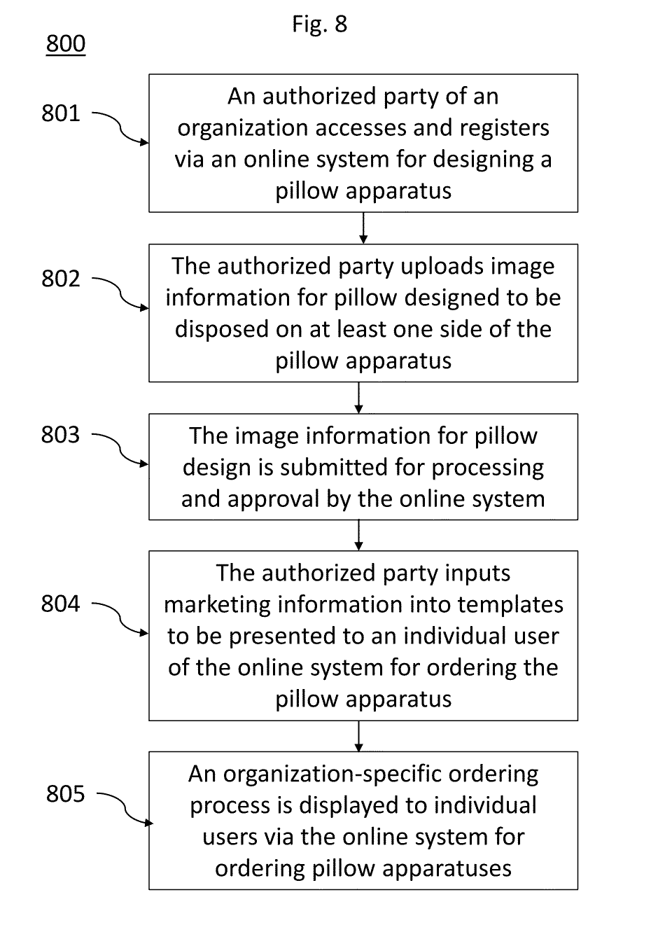

From operation 705, the process continues to operation 706 where a user is able to receive member recommended products and other items/articles. The process the continues to operation 707 where a user is able to view member created videos regarding designs of pillow apparatuses and receiving external/cross marketing offers. Other embodiments of the present invention also provide a social mobile component where a user can make and personalize their own pillow and submit any of their own art designs to be selected for permanent pre-made pillow apparatuses. The social network allows users to upload their design entries. A monthly design contest may implemented wherein the user can submit any art design/photo/saying for the pillow apparatus. A user will be selected and the design will be shown on the website/social network for other members and the general public to view and select for purchase as desired. The social application enables users to submit their artwork to the social network for the design contest, share their artwork and submission so other members can vote for them, design and purchase a pillow apparatus via their mobile phone and vote for other submissions via the social network. The present invention is not limited to being implemented via a social network, or ordering of a pillow apparatus via an individual user and may therefore be implemented via an organization or company, for marketing and fundraising efforts, for example. An exemplary embodiment will now be discussed below with reference to FIGS. 8 through 11B.

FIG. 8 is a flow diagram of a back end ordering process that can be implemented within one or more embodiments of the present invention. As shown in FIG. 8, at operation 801, an authorized party of the organization accesses and registers via an online system (e.g, a website provided for ordering and designing the pillow apparatus). The authorized party may be required to input contact information and other organization-specific information in order to register with the online system. The online system may be implemented in the form of a web application downloaded or installed at a user computing device. The user computing device may be a personal computer, portable computer (e.g., laptop, PDA), or mobile phone having a design application downloaded or installed thereon, for example.

Upon registering with the online system, account information is generated which is specific to the organization being registered, for example, an account number or code. The account number or code will be provided to individual users when ordering organization-specific pillow apparatuses.

From operation 802, where the authorized party uploads image information for pillow design, to be disposed on a side (e.g., a backside) of the pillow apparatus. According to one or more embodiments, the image information may include, for example, a logo or brand name of the organization, or other promotional/marketing information to be displayed to a customer of the organization. The side displaying the image information provided by the authorized party is a static side of the pillow apparatus. That is, the side of the pillow apparatus which will remain the same when orders are placed by individual users.

From operation 802, the process continues to operation 803, where the image information for pillow design is submitted for processing via a processor of a server of the online system. The processor analyzes the image information for pillow design and determines approval thereof. A sample of the pillow design is then provided to the authorized party for final approval thereof. The organization make select a theme or cause to be associated with the pillow design and a specific time period for which individual users may be able to order the specific pillow design. There is no limitation as to the number of pillow designs to be active for ordering by individual users. For example, an organization may have three (3) different pillow designs for individual users to select from. The organization is not limited to designing any particular number of pillow designs and may vary accordingly.

From operation 803, the process continues to operation 804, where the authorized party inputs marketing information into templates to be presented to an individual user of the online system for ordering the pillow apparatus. According to one or more embodiments, marketing information may include, for example, introduction/background information of the organization, for example, a cause or campaign for the organization, a template for ordering an organization-specific pillow apparatus, and a message/promotional insert to be inserted into the pillow apparatus, along with message templates (e.g., auto-responder to be sent to the individual user after the ordering process has been completed).

From operation 804, the process continues to operation 805, where an organization-specific ordering process is displayed to individual users via the online system at the user computing device, for ordering pillow apparatus. The organization-specific ordering process may be displayed to the user via the organization website or via the online system interfacing with the organization website. When accessing the online system directly, the user is required to input organization-specific information or make a cause/campaign selection to access, design and order an organization-specific pillow apparatus.

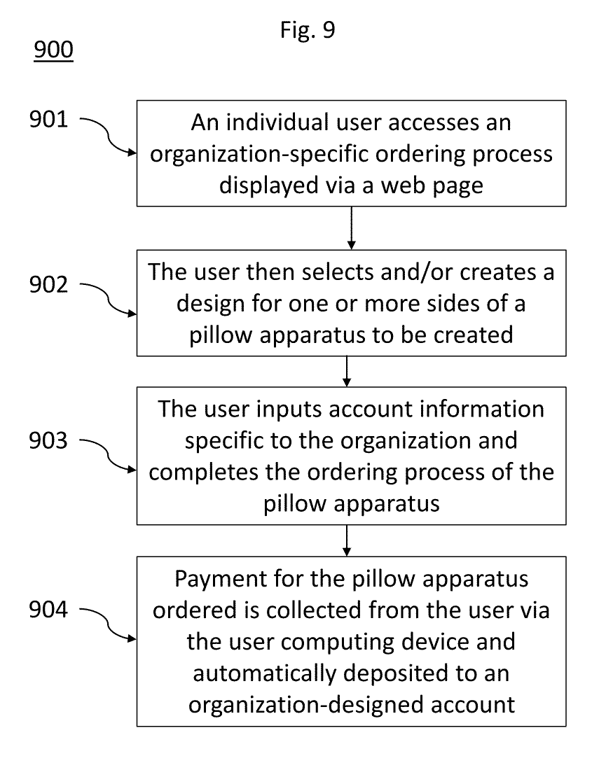

An exemplary embodiment of the front end ordering process by individual users will now be discussed below with reference to FIG. 9.

FIG. 9 is a flow diagram of a front end ordering process that can be implemented within one or more embodiments. As shown in FIG. 9, at operation 901, a user accesses an organization-specific webpage generated for ordering pillow apparatuses as discussed above with reference to FIG. 8. Alternatively, as previously mentioned above, a user may access the online system directly and select a cause or campaign for which the user wishes to place an order for a pillow apparatus. The user is not limited to only ordering pillow apparatuses directly from the organization-specific webpage.

From operation 901, the process continues to operation 902, where the user then selects and/or creates a design for one or more sides of the pillow apparatus to be created. The one or more sides are the dynamic sides of the pillow apparatus. These sides are able to be personalizes by the user when designing the pillow apparatus. For example, the organization may designate a back side of the first pillow, for example, for marketing and promotional information of the organization and the user may create a design for a front side of the first pillow of the pillow apparatus along with front and back sides of the second pillow of the pillow apparatus. According to other embodiments, the user may design for example, the second pillow only and the organization may design the first pillow. The present invention is not limited to any configuration of the pillow apparatus and may vary accordingly as desired by the organization or user.

From operation 902, the process continues to operation 903, where the user inputs account information specific to the organization and completes the ordering process of the pillow apparatus.

From operation 903, the process continues to operation 904, where payment for the pillow apparatus ordered is automatically collected and deposited to an organization-designated account for fundraising and marketing purposes.

According to one or more embodiments, the online system further provides a report of the sales of the pillow apparatuses based on the orders received via the organizations account information at the online system.

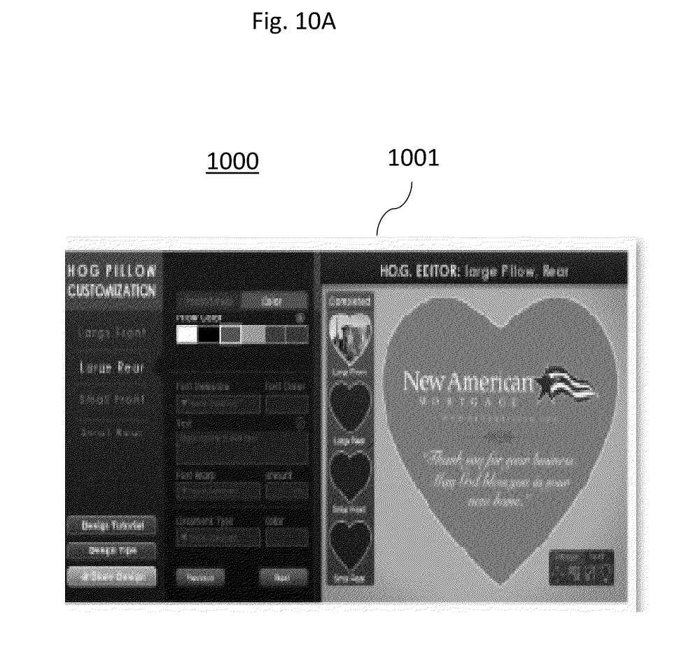

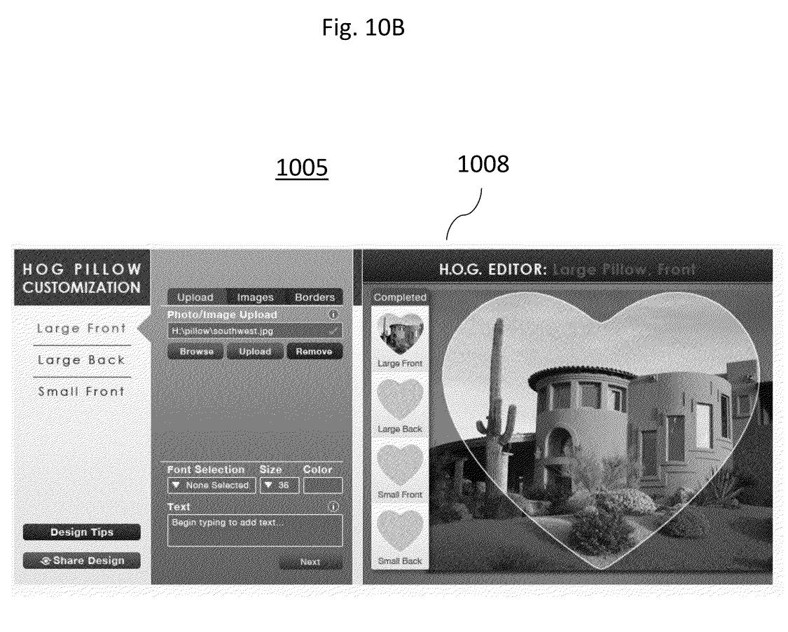

FIG. 10A and 10B are screenshots illustrating design operations of the wizard process of FIG. 9, for the first pillow of the pillow apparatus that can be implemented within one or more embodiments. As shown in FIG. 10A, a screenshot 1000 is provided, and displays a static pillow design 1001 including organization marketing information as designed by the organization.

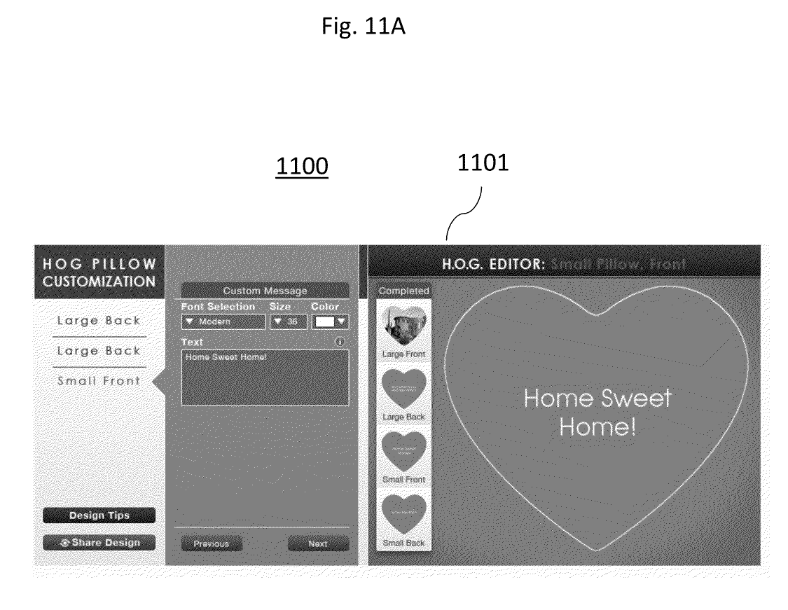

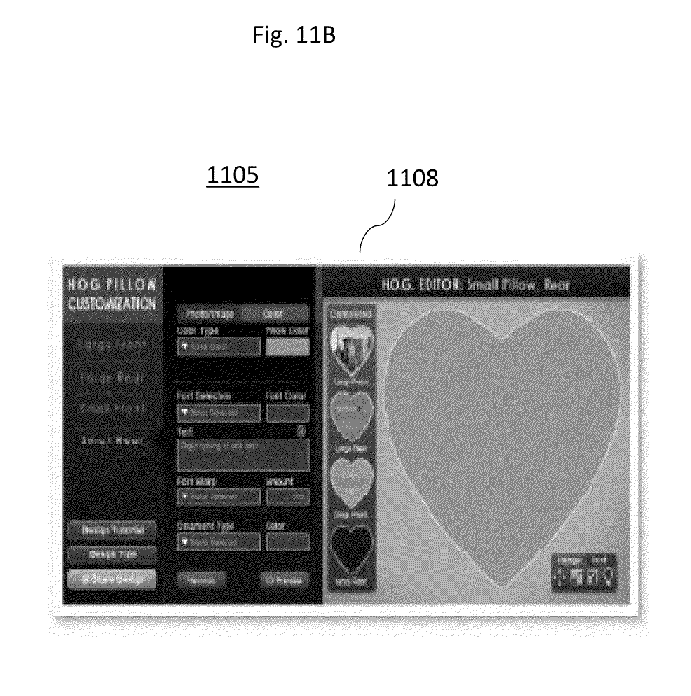

In FIG. 10B, a screenshot 1005 is provided and displays a front side 1008 of the pillow design to be created by the user. The user can select the parameters of the pillow design, for example, size, shape, colors associated with the front side 1008 of the pillow design. According to one or more embodiments, the user is able to also design a front side and back side of a pillow design for the second pillow to be inserted into the first pillow of the pillow apparatus. A detailed description of the design of the second pillow will be discussed below with reference to FIGS. 11A and 11B.

FIG. 11A and 11B are screenshots illustrating design operations of the wizard process of FIG. 8, for the second pillow of the pillow apparatus that can be implemented within one or more embodiments. As shown in FIG. 11A, screenshot 1100 displays a front side 1101 of the second pillow to be designed by the user. The user is able to select the parameters of the pillow design for the front side 1101.

As shown in FIG. 11B, screenshot 1105 is provided and displays a back side 1108 of the pillow design of the second pillow. According to one or more embodiments, the front side and back side may have the same or different designs thereon, as desired by the user.

According to one or more embodiments, pillow apparatuses may be created and ordered in bulk by an organization or company, for marketing purposes. The pillow apparatuses may include marketing information of the organization. The marketing and promotional information may for example, include audio or visual materials such as pamphlets, books, CDs, DVDs, gifts for the customers, etc. as desired by the organization.

According to one or more alternative embodiments, the individual user may receive or purchase the pillow apparatus in-person at the organization or a store, for example, and receive only a first part of the pillow apparatus (i.e., the first or second pillow in-person), whereby the first or second pillow may include a code or tag containing code information (e.g., QR or UPC code) for ordering the other of the first or second pillow online via the organization-specific webpage or the online system.

According to yet another alternative embodiment, the ordering process may be performed via a kiosk system at a location of an organization or company, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A pillow apparatus comprising:
a first pillow including a receiving pillow pocket in an interior portion thereof, and an opening at a side surface of the pillow corresponding to the receiving pillow pocket;
a second pillow formed of a different size than that of the first pillow; and
a connection portion configured to couple the first pillow and the second pillow together, wherein the second pillow is insertable into and housed within the receiving pillow pocket of the first pillow.

2. A social network operable via a computing device, and comprising a method including:
accessing the social network;
creating and storing a member profile;
creating at least one design of a pillow apparatus;
sharing the design with other members of the social network;
purchasing at least one design; following other members of the social network;
receiving member recommended products and other items/articles; and
viewing member created videos regarding designs of pillow apparatuses; and
receiving external/cross marketing offers.

3. The social network of claim 2, wherein the pillow apparatus comprises:
a first pillow including a receiving pillow pocket in an interior portion thereof, and an opening at a side surface of the pillow corresponding to the receiving pillow pocket;
a second pillow formed of a different size than that of the first pillow; and
a connection portion configured to couple the first pillow and the second pillow together, wherein the second pillow is insertable into and housed within the receiving pillow pocket of the first pillow.

4. A computer-implemented method of ordering a pillow apparatus, comprising:
accesses a website via a computing device;
creating a pillow design including a first pillow and a second pillow to be input within the first pillow;
purchasing the pillow apparatus based on the pillow design created.

5. The computer-implemented method of claim 4, wherein the computing device comprises at least one of a personal computer, portable computer, or mobile phone having a design application installed thereon.

6. The computer-implemented method of claim 5, wherein creating a pillow design comprises:
selecting a shape and size of the first pillow and the second pillow;
selecting a visual design to be disposed on the first pillow and the second pillow.

7. The computer-implemented method of claim 6, wherein the visual design to be disposed on the first pillow is a different visual design than that to be disposed on the second pillow.

8. The computer-implemented method of claim 4, wherein the creating of the pillow design comprises:
creating an organization-specific pillow apparatus comprising:
accesses and registering an organization via an online system for ordering the pillow apparatus;
uploading image information for pillow design of the organization-specific pillow apparatus;
processing and determining approval of the pillow design via the online system;
receiving marketing information for the organization, to be presented to an individual user when ordering the organization-specific pillow apparatus;
displaying an organization-specific ordering process to the individual user for ordering the organization-specific pillow apparatus.

9. The computer-implemented method of claim 8, wherein when accesses the organization-specific ordering process, the individual user selects and creates a design for one or more sides of the organization-specific pillow apparatus, inputs account information specific to the organization; and orders the organization-specific pillow apparatus.

10. The computer-implemented method of claim 9, wherein payment for the organization-specific pillow apparatus is automatically collected and deposited to an organization-designated account.
